(19) United States
(12) Patent Application Publication
(10) Pub. No.: US 2026/0153107 A1
(43) Pub. Date: Jun. 4, 2026

(54) Fastener with Wear Surface

(71) Applicant: Illinois Tool Works Inc., Glenview, IL (US)

(72) Inventors: Jason Zander, Roberts, WI (US); Emily Wunsch, Eau Claire, WI (US)

(21) Appl. No.: 19/401,519

(22) Filed: Nov. 26, 2025

Related U.S. Application Data
(60) Provisional application No. 63/727,277, filed on Dec. 3, 2024.

(51) Int. Cl. F16B 5/06; B60R 13/02; B62D 27/00; F16B 21/07

(52) U.S. Cl. CPC F16B 5/065; F16B 21/075; B60R 13/0206; B62D 27/00

(57) ABSTRACT

Disclosed is a fastener for coupling a first component to a second component. The fastener includes a body portion and a head portion that extends from the body portion. The body portion includes a plurality of ribs connected to one another via a bridge at a bend section to define a clip channel that is to receive a clip tower. The head portion includes a plurality of arms. Each of the plurality of arms is coupled to a respective one of the plurality of ribs at a connection point. An engagement-wear region is disposed on an exterior surface of at least one of the arms or ribs, the engagement-wear region comprising a core surface region, a double-tapered engagement surface region, and an edge region.

### RELATED APPLICATION

The present application claims priority to U.S. Provisional Patent Application No. 63/727,277, filed Dec. 3, 2024, and entitled “Riblok with Taper for Wear Surface,” which is hereby incorporated by reference in its entirety.

### BACKGROUND

Automotive components require fastening techniques that are simple to manufacture and assemble. Further, fastening techniques should above all be reliable and efficient. In order to secure a secondary panel to a primary panel, a fastener may be used, such as a pin and grommet fastener.

Various types of fasteners are used for fastening components. For example, in the case of an instrument panel of a vehicle, fasteners may be used to fix together adjacent panels or to secure one or more objects on the panels. One such type of fastener is usable with holes of different types, sizes, and shapes provided in the components to be secured together. In other words, for such a fastener to fasten the components, at least one of the components is provided with a hole. One of the components is mounted on the fastener and the other component having the hole receives the fastener component assembly.

Therefore, despite various advancements to date, it would nevertheless be desirable to provide a further improved plastic fastener.

### SUMMARY

The present disclosure relates generally to a fastening system to form a blind connection between the panels, such as automotive panels, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates an isometric assembly view of a fastening system in accordance with an aspect of the illustrate disclosure.

FIGS. 2A through 2C illustrate side views of the fastening system at successive stages of assembly.

FIGS. 3A and 3B illustrate top-side and underside isometric views of the fastener, respectively.

FIGS. 3C and 3D illustrate front and rear elevation views of the fastener.

FIGS. 3E and 3F illustrate first and second side elevation views of the fastener.

FIGS. 3G and 3H illustrate top-side and underside plan views of the fastener, respectively.

FIG. 4A illustrates a detailed view of the engagement-wear region of the fastener.

FIG. 4B illustrates cross-sectional views of the engagement-wear region taken along line A-A of FIG. 3C.

FIGS. 5A through 5C illustrate isometric detailed views of the engagement-wear region at three different wear conditions.

FIGS. 6A through 6C illustrate additional isometric detailed views of the engagement-wear region at the same three wear conditions.

FIGS. 7A through 7C illustrate side elevation views of the engagement-wear region of the fastener at the three wear conditions.

### DESCRIPTION

References to items in the singular should be understood to include items in the plural, and vice versa, unless explicitly stated otherwise or clear from the text. Grammatical conjunctions are configured to express any and all disjunctive and conjunctive combinations of conjoined clauses, sentences, words, and the like, unless otherwise stated or clear from the context. Recitation of ranges of values herein are not configured to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

In one example, a plastic fastener comprises: a fastener body having at least one exterior surface configured to contact a component during installation or removal; and at least one engagement-wear region formed on the exterior surface, wherein the engagement-wear region is shaped such that material removal from the engagement-wear region during use increases a contact surface area configured to engage the component.

In some examples, the engagement-wear region comprises a core surface region, a double-tapered engagement surface region, and an edge region.

In some examples, the double-tapered engagement surface region comprises a first taper in a widthwise direction of the fastener body and a second taper in a longitudinal direction of the fastener body.

In some examples, the double-tapered engagement surface region is positioned between the core surface region and the edge region.

In some examples, the engagement-wear region extends along a length of the fastener body.

In some examples, wear of the engagement-wear region decreases an engagement length of the fastener in a direction of disengagement.

In some examples, the engagement-wear region is integrally formed with the fastener body.

In some examples, the fastener is configured to engage a sheet-metal component.

In some examples, the plastic comprises polypropylene, polyamide, acetal, ABS, polyethylene, or combinations thereof.

In another example, a fastener comprises: a body portion having a pair of ribs extending along a length of the fastener; a head portion having a pair of arms, each arm extending from a corresponding rib; and an engagement-wear region disposed on an exterior surface of at least one of the arms or ribs, wherein the engagement-wear region is configured to engage a component surface during insertion or extraction of the fastener, and wherein material removal from the engagement-wear region during use increases a contact surface area between the fastener and the component.

In some examples, the engagement-wear region comprises a core surface region, a double-tapered engagement surface region, and an edge region.

In some examples, the double-tapered engagement surface region comprises a first taper in a widthwise direction of the fastener and a second taper in a lengthwise direction of the fastener.

In some examples, the double-tapered engagement surface region is positioned between the core surface region and the edge region.

In some examples, the engagement-wear region extends along at least a portion of a length of the arm.

In some examples, the increase in contact surface area resulting from wear maintains or increases a separation force required to remove the fastener from the component.

In some examples, wear of the engagement-wear region reduces an engagement length of the fastener in a direction of disengagement.

In some examples, the fastener is formed from a polymeric material.

In some examples, the fastener further comprises a clip channel configured to receive a clip tower of a second component.

In yet another example, a plastic fastener comprises: a body portion having a pair of ribs extending along a length of the fastener; a head portion having a pair of arms, each arm extending from a corresponding rib; and an engagement-wear region disposed on an exterior surface of at least one of the arms or ribs, the engagement-wear region comprising a core surface region, a double-tapered engagement surface region, and an edge region, wherein the double-tapered engagement surface region includes a first taper in a widthwise direction of the fastener and a second taper in a lengthwise direction of the fastener, wherein the engagement-wear region extends along at least a portion of a length of the arm or leg, and wherein material removal from the engagement-wear region during insertion or extraction increases a contact surface area between the fastener and the component.

In some examples, the engagement-wear region comprises a core surface region, a double-tapered engagement surface region, and an edge region.

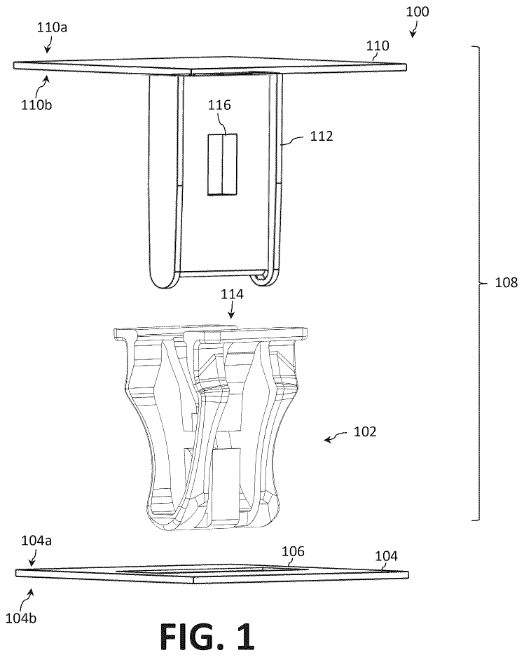

FIG. 1 illustrates an isometric assembly view of a fastening system 100 in accordance with an aspect of this disclosure. The illustrated fastening system 100 comprises a fastener 102 configured to connect a first component 104 to a second component 110 via a clip tower 112 associated with the second component 110. The fastener 102 facilitates a connection between the first component 104 and the second component 110. The first component 104 and the second component 110 may be, for example, automotive panels.

The first component 104, the second component 110, and the clip tower 112 can be manufactured from materials such as metals; synthetic or semi-synthetic polymers (e.g., acrylonitrile butadiene styrene (ABS), polyvinyl chloride (PVC)); composite materials (e.g., fiberglass); or combinations thereof. In automotive applications, these panels may include door trim panels, moldings, trim pieces, hoods, doors, pillars (e.g., A-pillar, B-pillar, C-pillar), dashboard components (e.g., cross members, brackets, frames), seat frames, center consoles, fenders, sheet-metal frameworks, and other substrates used for interior or exterior surfaces.

The first component 104 comprises one or more openings 106, while the second component 110 includes one or more clip towers 112 having, for example, a seating portion 116. Each opening 106 is configured to receive or engage the fastener 102 and its corresponding clip tower 112. The fastener 102 and its corresponding clip tower 112 can be provided as a part-in-assembly (PIA) component 108. The clip towers 112 are configured to engage the fasteners 102 via, for example, features of the fasteners 102 and the seating portion 116. The first component 104 defines an A-surface 104a and a B-surface 104b (undersurface), and similarly, the second component 110 defines an A-surface 110a and a B-surface 110b (undersurface). The A-surface 104a of the first component 104 is the outward-facing surface, while the B-surface 104b is the inward-facing surface. Upon assembly, the A-surface 104a of the first component 104 faces the B-surface 110b of the second component 110.

The A-surface 110a, also known as a class-A surface, remains visible post-assembly and is often aesthetically enhanced (e.g., textured, coated, or decorated) and typically free from attachment devices or related features. In contrast, the B-surface 110b, or class-B surface, is concealed after assembly and usually incorporates various attachment devices or related features. For example, in a vehicle's instrument panel, the second component 110 could be a dashboard and the first component 104 an instrument cluster mounted onto the dashboard, or vice versa.

The second component 110 may incorporate attachment devices or features, such as the clip towers 112, which protrude from the B-surface 110b. Each clip tower 112 is generally perpendicular to the second component 110 and may include a seating portion 116, such as a slot or window, configured to receive or engage a portion of the fastener 102. The clip towers 112 can be integral with the second component 110 (e.g., co-molded) or attached separately (e.g., using adhesive).

The fastener 102 can be secured onto the clip tower 112 of the second component 110, forming a PIA component 108. For example, the fastener 102 defines a clip channel 114 configured to receive at least a portion of the clip towers 112 (e.g., starting at a leading end of the clip tower 112). The PIA component 108 can then be attached to the first component 104 by an end user. In some scenarios, the PIA component 108 is pre-assembled at the factory and shipped to the end user for final assembly with the first component 104.

In some examples, the fastener 102 is configured to be ergonomic during insertion into the opening 106 of the first component 104, requiring a relatively low insertion force. However, during separation or withdrawal from the opening 106, the fastener 102 may necessitate a considerably higher force compared to insertion. In other words, the fastener 102 is configured to have a low insertion force but a relatively high separation force. Notably, the insertion and separation forces are independent of each other.

The fastener 102 may be constructed from a generally rigid material, such as plastic. The fastener 102 may be fabricated from synthetic or semi-synthetic polymers, such as polypropylene (PP), ABS, polycarbonate (PC), polymethylmethacrylate (PMMA), polyoxymethylene (POM), or a combination thereof. Notably, the fastener 102 can be fabricated from plastic while remaining suitable for use with metal components. Thus, in one example, the fastener 102 is made from plastic, while the first component 104 and/or the second component 110 are metal, plastic, composite, etc.

The fastener 102 can be formed via a plastic injection-molding process. In other examples, the fastener 102 may be a printed thermoplastic component formed via additive-manufacturing techniques, which can be advantageous for creating complex or detailed features. Additive manufacturing eliminates the need for mold tooling associated with injection molding, reducing initial manufacturing costs—particularly beneficial for low-volume production. Example additive-manufacturing processes include material extrusion (e.g., fused deposition modeling (FDM)), stereolithography (SLA), selective laser sintering (SLS), material jetting, binder jetting, powder-bed fusion, directed-energy deposition, or VAT photopolymerization.

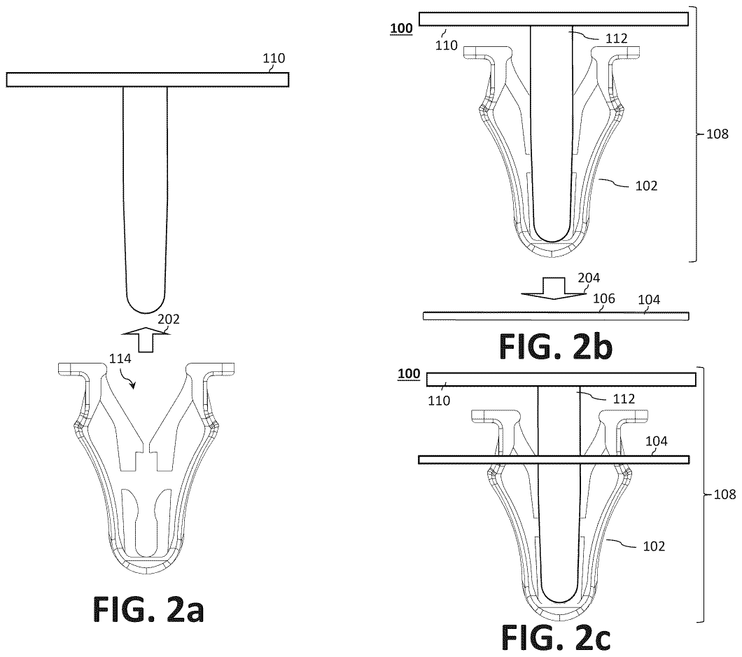

FIGS. 2A through 2C illustrate side views of an example fastening system 100 in different stages of assembly. Specifically, FIG. 2A illustrates a second component 110 with a fastener 102 being slipped onto the clip tower 112 of the second component 110 as indicated by arrow 202 to define the PIA component 108. FIG. 2B illustrates the fastener 102 and clip tower 112 of the assembled PIA component 108 being at least partially inserted into the opening 106 of the first component 104 as indicated by arrow 204. FIG. 2C illustrates the PIA component 108 fully assembled with the first component 104.

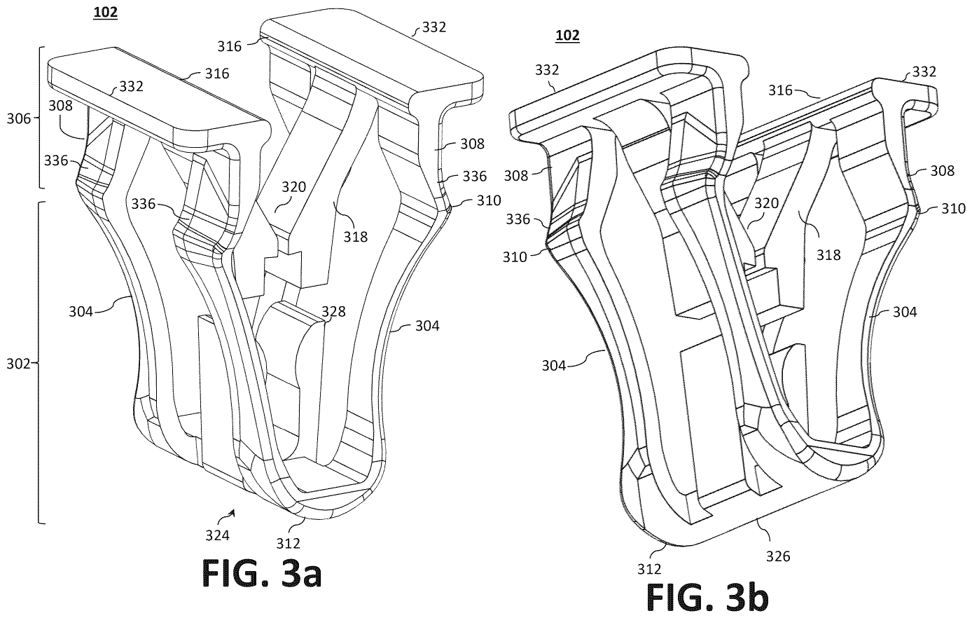

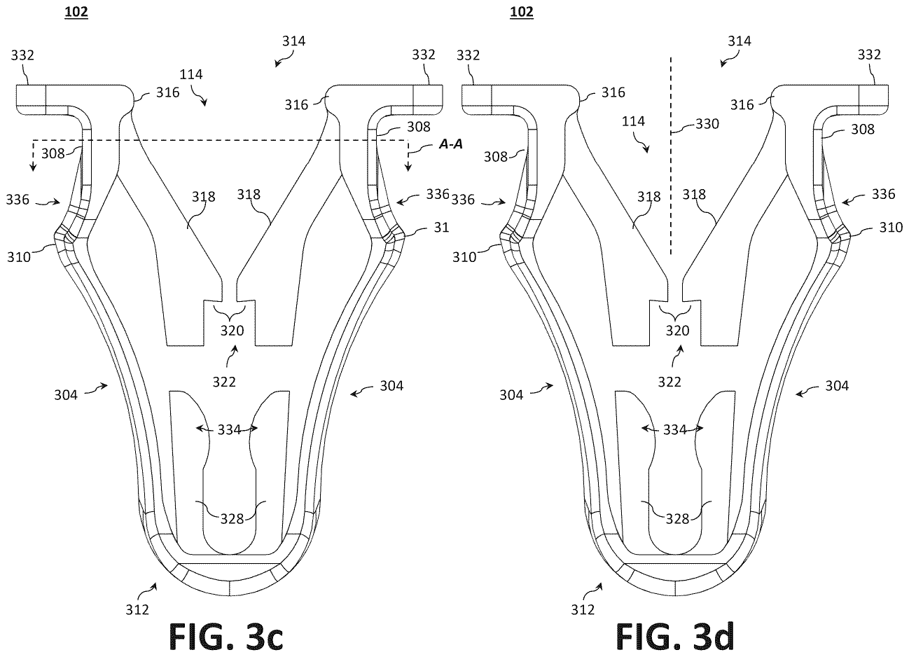

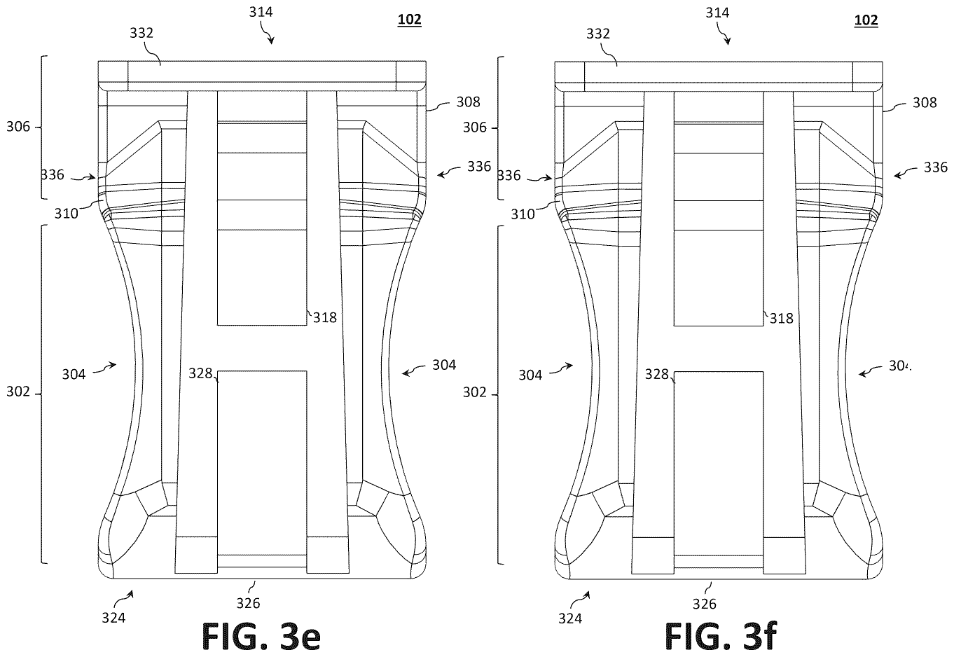

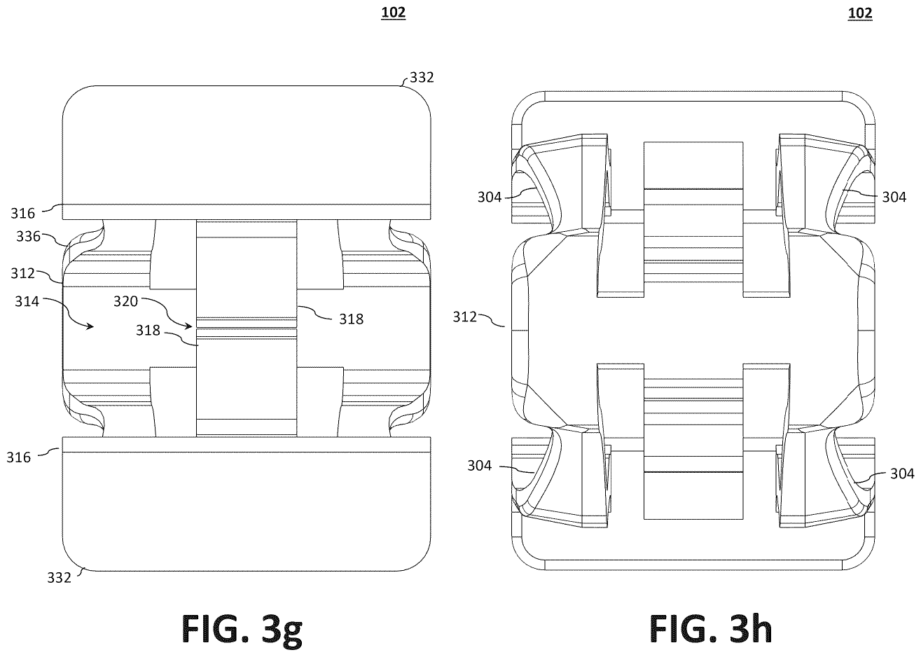

FIGS. 3A through 3H illustrate detailed views of the fastener 102 of FIG. 1 and FIGS. 2A through 2C. Specifically, FIGS. 3A and 3B illustrate top-side and underside isometric views of the fastener 102, respectively. FIGS. 3C and 3D illustrate front and rear elevation views of the fastener 102, while FIGS. 3E and 3F illustrate first and second side elevation views. FIGS. 3G and 3H illustrate top-side and underside plan views, respectively. For brevity and ease of understanding, FIGS. 3A through 3E are described in conjunction with each other.

The fastener 102 generally comprises a body portion 302 and a head portion 306 that collectively defines a first end 314 and a second end 324. The body portion 302 comprises a plurality of ribs 304. As illustrated, two sets of parallel ribs 304 are joined at one end via a bend section 312 at the leading end (e.g., the second end 324), creating the clip channel 114 with a generally U-shaped or V-shaped profile when viewed from the side, as shown in FIGS. 3C and 3D. The bend section 312 defines the second end 324, which is opposite the first end 314.

Extending from the body portion 302 is a head portion 306, which includes a plurality of arms 308. Each arm 308 is connected to a free end of a rib 304 and extends away from the body portion 302 (i.e., away from the second end 324 and toward the first end 314). The arms 308 are arranged as two sets of parallel arms 308 (corresponding to and extending from the two sets of ribs 304) that are joined at one end at a connecting element 316 at the trailing end (e.g., the first end 314). The arms 308 are cantilevered at their connection points 310 to form an angle relative to the ribs 304, allowing them to hinge or flex at the junction between each arm 308 and rib 304. The connecting element 316 is positioned at the first end 314 of the fastener 102.

Accordingly, the fastener 102 includes two connecting elements 316 at the first end 314, one on each side of the bend section 312. Each connecting element 316 comprises a wing feature 332 that extends away from the axis 330. The connecting element 316 is shaped to define the wing feature 332 at its distal end, extending outwardly from the fastener 102. In operation, the engagement features 332 can be used by the user to grasp the fastener 102 (e.g., during installation or removal from a clip tower 112) or to engage the first component 104 and/or the second component 110. For example, the engagement features 332 can be configured to prevent the fastener 102 from passing entirely through the opening 106, thus serving as a stop or as a spring (e.g., to mitigate buzz, squeak, and rattle (BSR)).

Additionally, the fastener 102 can comprise multiple mounting brackets 318 for attachment to the second component 110. In one example, at least one mounting bracket 318 is provided on each side of the axis 330. The mounting brackets 318 are supported by the connecting elements 316 at the first end 314. Each mounting bracket 318 includes a seat 320 that cooperates with a corresponding seat 320 to define a region that receives and accommodates a portion of the second component 110. The seats 320 on either side of the bend section 312 form a clip-tower cavity 322 (or other recess) configured to receive the portion of the second component 110 to be mounted onto the fastener 102. For instance, the second component 110 may have a protrusion extending from a clip tower 112 that cooperates with the clip-tower cavity 322 of the mounting brackets 318 to secure the second component 110 to the fastener 102. In one example, the clip tower 112 includes a seating portion 116 (illustrated as a cutout or opening). When assembled, the clip-tower cavity 322 of the fastener 102 engages the seating portion 116. For example, the clip tower 112 can snap-fit within the clip-tower cavity 322 of the fastener 102 via the seats 320.

Once the fastener 102 is mounted onto the second component 110 (e.g., via the clip tower 112), the assembly can be inserted into the opening 106 of the first component 104, thereby joining the first component 104 and the second component 110. For example, the fastener 102 can be inserted into the opening 106 of the first component 104 with the second end 324 entering first, as indicated by arrow 204 in FIG. 2B. The second end 324 may be tapered and/or chamfered to facilitate insertion. The previously described seats 320 and seating portion 116 help prevent the fastener 102 from disengaging from the clip tower 112 during subsequent disassembly of the first component 104 relative to the second component 110. In other words, the fastening system 100 can be disassembled such that the first component 104 and the fastener 102 disengage, while the fastener 102 remains attached to the clip tower 112 of the second component 110.

At the second end 324 of the fastener 102, i.e., at the bend section 312, the ribs 304 are joined by a bridge 326. The bridge 326 is configured to couple the ribs 304 while retaining their flexibility during insertion into the opening 106. In some examples, the ribs 304 are tapered along their length to enhance flexibility without compromising strength, allowing the ribs 304 to bend during insertion and return to their original span without failure.

The grasping element 328 includes a mating face 334 configured to contact the surface of the clip tower 112. This mating face 334 tapers from the first end 314 toward the second end 324. In other words, the mating face 334 tapers from the bend section 312 along the body portion 302, aligning with the extension direction of the fastener 102. During assembly, the mating face 334 of the grasping elements 328 engages the tip of the clip tower 112, facilitating self-centering of the clip tower 112 relative to the fastener 102. The previously described seats 320 secure the fastener 102 to the clip tower 112 via the seating portion 116.

The taper of the mating face 334 also complements the tapered shape of the ribs 304, guiding the second component 110—specifically, the clip tower 112—toward the center of the bend section 312 during mounting to the fastener 102. This design ensures effective attachment of the second component 110 to the fastener 102.

The fastener 102 is engineered considering both the insertion force required to insert it into the opening 106 and the separation force needed for its removal. In one aspect, the fastener 102 is configured so that the insertion force does not influence the separation force, and vice versa. For example, the fastener 102 may necessitate a nominal insertion force for user ergonomics, while simultaneously requiring a significantly higher separation force compared to the insertion force.

In certain aspects, the bridge 326 is dimensioned to be small, enhancing the flexibility of the ribs 304 at the bend section 312 and thereby reducing the insertion force. Additionally, the size of the bridge 326 is selected to prevent failure or breakage of the fastener 102 during multiple insertion and withdrawal cycles, such as five or more. Thus, the dimensions of the bridge 326 are optimized based on a balance between insertion force and structural integrity. Material selection for the fastener 102 also influences the sizing of the bridge 326.

The design of the ribs 304 further affects insertion force. To enhance their flexibility without compromising strength, the ribs 304 may feature a tapered shape along their length. Increased flexibility allows the fastener 102 to require only a nominal insertion force, enabling the ribs 304 to bend during entry into the opening 106 and subsequently return to their original shape without failure.

In some aspects, features of the fastener 102 are tailored based on the required separation force—the force necessary to withdraw the fastener 102 from the first component 104. For instance, the fastener 102 may be configured to withstand a separation force of at least 130 Newtons (N), while the insertion force remains below approximately 45 N. These values are exemplary and not limiting; depending on design and application, the nominal insertion and high separation forces may vary beyond the specified ranges.

In certain aspects, the fastener 102 further includes one or more tapered wear regions 336 configured to regulate material removal during repeated installation and removal cycles of the fastener 102 (or to account for wear from movement caused by vibration). The engagement-wear region 336 is positioned on an exterior surface of the fastener 102 that is configured to contact a component 104, such as when the fastener 102 is inserted into or removed from an opening 106 of the component 104.

Although the engagement-wear region 336 is illustrated in connection with a U-shaped fastener having ribs 304 and arms 308, the engagement-wear region 336 may be incorporated into any plastic fastener design, including clips, retainers, barbed fasteners, arrow-head fasteners, tree-type fasteners, and hybrid fasteners. Accordingly, the engagement-wear region 336 should not be construed as limited to channel-clip configurations or any specific structural arrangement.

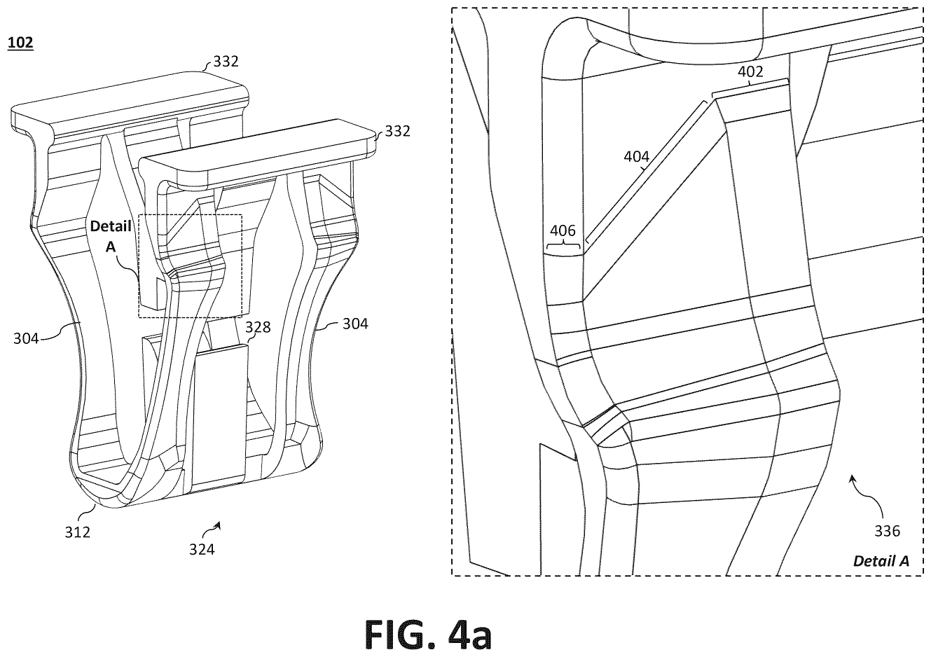

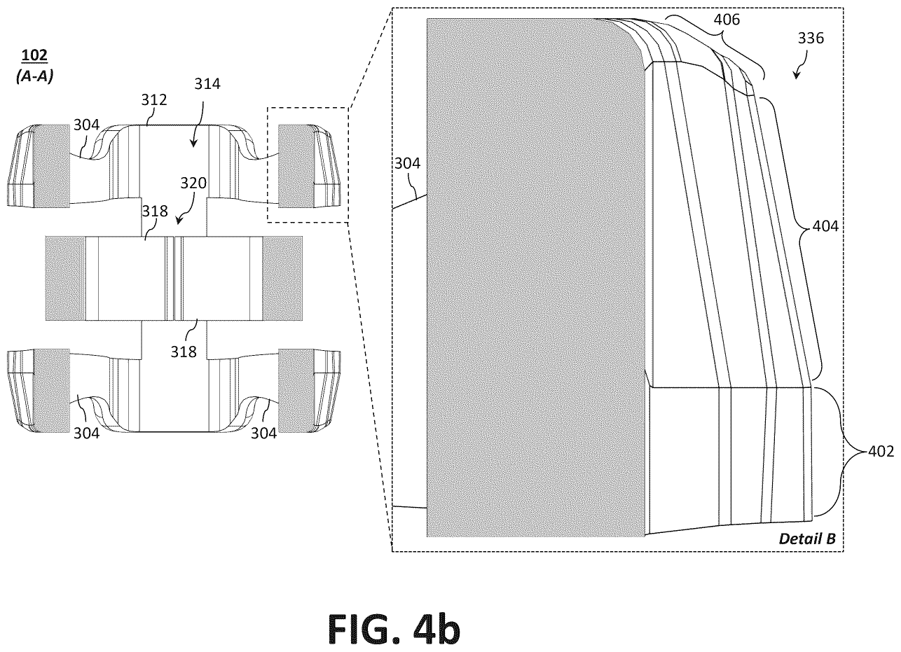

As shown in FIGS. 4A and 4B, an engagement-wear region 336 can be positioned at or near the junction between each arm 308 and its corresponding rib 304, particularly along the outer surface of the arm 308 facing away from the clip channel 114. The engagement-wear region 336 is integrally formed with the fastener body 302, such as through the plastic injection molding or additive manufacturing process, resulting in a monolithic structure without joints or secondary wear inserts. The placement of the engagement-wear region 336 at the “arm-to-rib junction” helps to ensure that wear forces encountered during insertion or removal are at the tapered region 336, yielding predictable and controlled wear behavior.

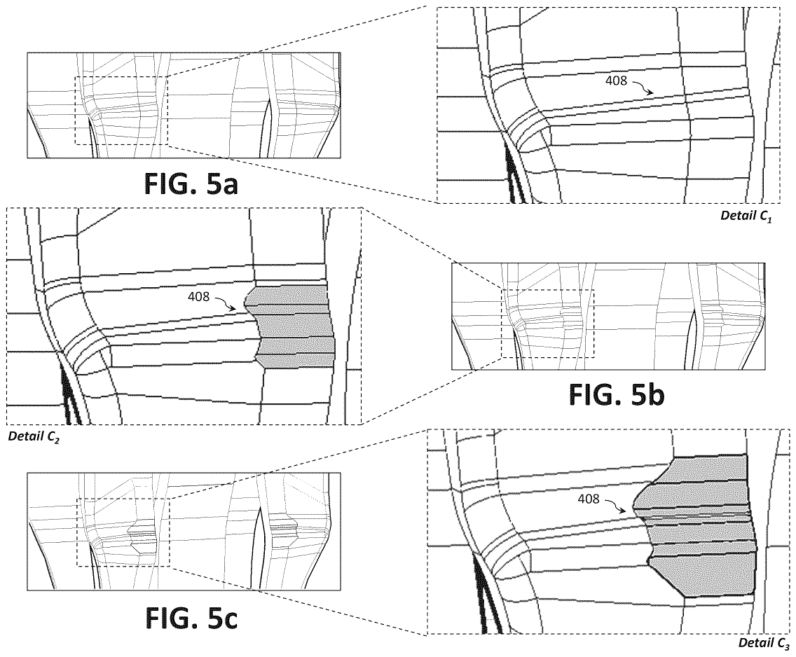

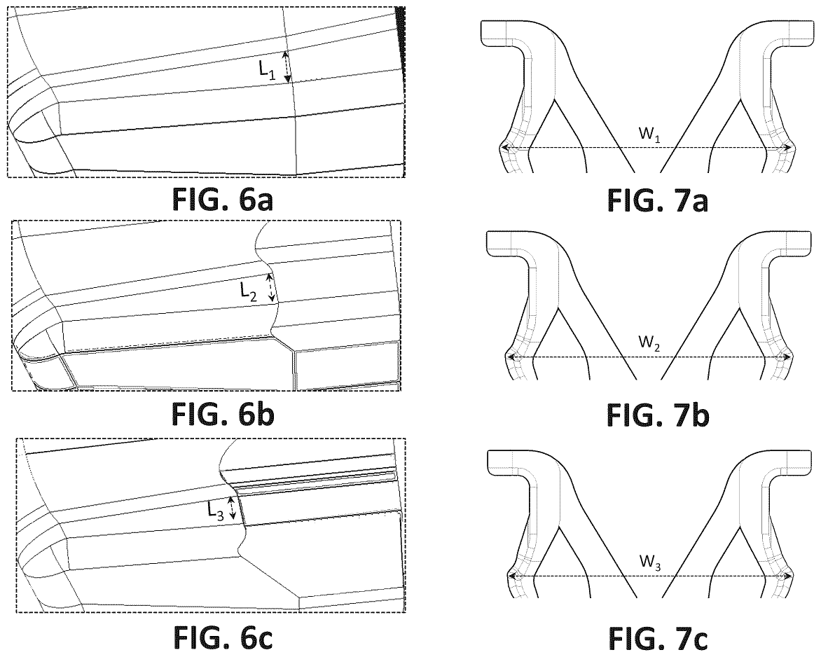

As illustrated in FIGS. 5A through 7C, the engagement-wear region 336 generally comprises a core surface region 402, a double-tapered engagement surface region 404, and an edge region 406. The core surface region 402 represents the thickest portion of the engagement-wear region 336, while the double-tapered engagement surface region 404 transitions between the core surface region 402 and the edge region 406 aspect. The double-tapered engagement surface 404 tapers in at least two directions, including a widthwise taper (see widths W₁, W₂, W₃) and a longitudinal taper extending along the length of the arm 308 (see lengths L₁, L₂, L₃). The double-tapered engagement surface 404 is, for example, contoured and sloped to provide a smooth transition between the core surface region 402 and the edge region 406 where, as the double-tapered engagement surface 404 is worn, the contact area increases. These taper geometries define a multi-angle profile that changes gradually and is a predictable (e.g., a controlled manner) as material is worn away.

FIGS. 5A, 6A, and 7A illustrate the fastener 102 in a new or unworn condition in which the core surface region 402 at the contact region 408 is fully intact. In this state, the engagement surface length corresponds to L₁, and the width of the engagement-wear region corresponds to W₁, representing the maximum dimensions of the engagement profile. During initial installation, the engagement-wear region 336 contacts the component 104 along these original surfaces. Through use, the fastener 102 becomes worn at, inter alia, the engagement-wear region 336.

FIGS. 5B, 6B, and 7B illustrate the engagement-wear region 336 after minimal use. The core surface region 402 exhibits partial wear at the contact region 408, resulting in a reduced engagement length L₂ and a reduced width W₂. Material removal exposes more of the double-tapered engagement surface region 404, which increases the actual surface contact area between the fastener 102 and the component 104. Despite the material loss, this increase in contact surface area at the contact region 408 maintains or increases frictional engagement with the component 104. Through continued use, the fastener 102 becomes further worn at, inter alia, the engagement-wear region 336.

FIGS. 5C, 6C, and 7C illustrate a fastener 102 that has experienced moderate wear at the contact region 408 during extended use. In this condition, the core surface region 402 is further diminished, and the engagement length is reduced to L₃, while the width narrows to W₃. As wear progresses, the core surface region 402 becomes increasingly flush with the double-tapered engagement surface region 404. Although the overall thickness and width decrease, the total frictional interface area increases due to exposure of additional tapered surfaces. This effect compensates for material loss and stabilizes retention force.

During operation, insertion of the fastener 102 into the opening 106 causes the engagement-wear region 336 to engage the component 104, thereby generating friction that results in gradual wear. The geometry of the engagement-wear region 336 causes two simultaneous effects as material is removed: (1) an increase in frictional surface area due to exposure of deeper tapered regions, and (2) a decrease in the engagement length of the arm 308 in the direction of disengagement. The combination of these effects provides a self-regulating wear mechanism that maintains extraction force within a desired performance range over multiple installation cycles.

The engagement-wear region 336 may be applied to any portion of the fastener 102 subject to frictional wear, including ribs 304, arms 308, retention tabs, flexible fingers, or barbed regions. The angles, lengths, and taper geometries of the core surface region 402, double-tapered engagement surface region 404, and edge region 406 may be adjusted based on the intended wear rate, component material hardness, or desired retention characteristics. As noted, suitable materials for forming the fastener 102 include, inter alia, polypropylene, polyamide, acetal, ABS, polyethylene, and mixtures or composites thereof, optionally including reinforcing fibers or lubricating additives to tailor durability and friction behavior.

As can be appreciated, an engagement-wear region 336 is configured to provide a controlled, predictable wear profile that facilitates consisted fastener performance over time. That is, as material is worn away at the engagement location, the engagement-wear region 336 increases the contact surface area, compensating for the reduction in extraction force that would otherwise result from material loss. In addition, the engagement-wear region 336 reduces (e.g., via the engagement surface region 404) the length of the engagement surface in the direction of disengagement as wear occurs, preventing overcompensation and helping maintain substantially consistent disengagement forces across repeated installation cycles.

Although the engagement-wear region 336 is illustrated with a clip-type fastener, it is compatible with virtually any plastic fastener subjected to wear from contact with a mating component, including metal components. Thus, the engagement-wear region 336 should not be construed as limited to the illustrated aspects, but rather applicable to a wide range of fastening systems requiring reliable long-term retention.

While the present method and/or system have been described with reference to certain implementations, it will be understood by those skilled in the art that various changes may be made and equivalents may be substituted without departing from the scope of the present method and/or system. Therefore, although examples for fasteners have been described in language specific to structural features and/or methods, it is to be understood that the appended claims are not limited to the specific features described. Rather, the specific features are disclosed as examples of fasteners. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A plastic fastener comprising:
a fastener body having at least one exterior surface configured to contact a component during installation or removal; and
at least one engagement-wear region formed on the exterior surface,
wherein the engagement-wear region is shaped such that material removal from the engagement-wear region during use increases a contact surface area configured to engage the component.

2. The plastic fastener of claim 1, wherein the engagement-wear region comprises a core surface region, a double-tapered engagement surface region, and an edge region.

3. The plastic fastener of claim 2, wherein the double-tapered engagement surface region comprises a first taper in a widthwise direction of the fastener body and a second taper in a longitudinal direction of the fastener body.

4. The plastic fastener of claim 2, wherein the double-tapered engagement surface region is positioned between the core surface region and the edge region.

5. The plastic fastener of claim 1, wherein the engagement-wear region extends along a length of the fastener body.

6. The plastic fastener of claim 1, wherein wear of the engagement-wear region decreases an engagement length of the fastener in a direction of disengagement.

7. The plastic fastener of claim 1, wherein the engagement-wear region is integrally formed with the fastener body.

8. The plastic fastener of claim 1, wherein the fastener is configured to engage a sheet-metal component.

9. The plastic fastener of claim 1, wherein the plastic comprises polypropylene, polyamide, acetal, ABS, polyethylene, or combinations thereof.

10. A fastener comprising:
a body portion having a pair of ribs extending along a length of the fastener;
a head portion having a pair of arms, each arm extending from a corresponding rib; and
an engagement-wear region disposed on an exterior surface of at least one of the arms or ribs,
wherein the engagement-wear region is configured to engage a component surface during insertion or extraction of the fastener, and
wherein material removal from the engagement-wear region during use increases a contact surface area between the fastener and the component.

11. The fastener of claim 10, wherein the engagement-wear region comprises a core surface region, a double-tapered engagement surface region, and an edge region.

12. The fastener of claim 11, wherein the double-tapered engagement surface region comprises a first taper in a widthwise direction of the fastener and a second taper in a lengthwise direction of the fastener.

13. The fastener of claim 11, wherein the double-tapered engagement surface region is positioned between the core surface region and the edge region.

14. The fastener of claim 10, wherein the engagement-wear region extends along at least a portion of a length of the arm.

15. The fastener of claim 10, wherein an increase in contact surface area resulting from wear maintains or increases a separation force required to remove the fastener from the component.

16. The fastener of claim 10, wherein wear of the engagement-wear region reduces an engagement length of the fastener in a direction of disengagement.

17. The fastener of claim 10, wherein the fastener is formed from a polymeric material.

18. The fastener of claim 10, further comprising a clip channel configured to receive a clip tower of a second component.

19. A fastener for attached to a component, the fastener comprising:
a body portion having a pair of ribs extending along a length of the fastener;
a head portion having a pair of arms, each arm extending from a corresponding rib; and
an engagement-wear region disposed on an exterior surface of at least one of the arms or ribs, the engagement-wear region comprising a core surface region, a double-tapered engagement surface region, and an edge region,
wherein the double-tapered engagement surface region includes a first taper in a widthwise direction of the fastener and a second taper in a lengthwise direction of the fastener,
wherein the engagement-wear region extends along at least a portion of a length of the arm or leg, and
wherein material removal from the engagement-wear region during insertion or extraction increases a contact surface area between the fastener and the component.

20. The fastener of claim 10, wherein the engagement-wear region comprises a core surface region, a double-tapered engagement surface region, and an edge region.
